(19) United States
(12) Patent Application Publication
(10) Pub. No.: US 2024/0329273 A1
(43) Pub. Date: Oct. 3, 2024

(54) BIT-SYMBOL MAPPING METHOD FOR MULTI-PULSE POSITION MODULATION IN PETROLEUM DRILLING EXPLORATION

(71) Applicant: Univ. Electronic Science and Technology of China, Chengdu (CN)

(72) Inventors: Wei CHEN, Chengdu (CN); Xiufeng LI, Chengdu (CN); Xu ZHANG, Chengdu (CN); Qingshui GU, Chengdu (CN); Ruiqing WU, Chengdu (CN); Conglin YE, Chengdu (CN); Jingyi LIN, Chengdu (CN)

(21) Appl. No.: 18/417,107

(22) Filed: Jan. 19, 2024

(30) Foreign Application Priority Data
Mar. 31, 2023 (CN) 2023103337514

(51) Int. Cl. G01V 1/50; E21B 47/20; E21B 49/00

(52) U.S. Cl. CPC G01V 1/50; E21B 47/20; E21B 49/00

(57) ABSTRACT

Disclosed is a bit-symbol mapping method using multi-pulse position modulation (MPPM), which relevant to the field of signal processing. An index of each dimension of an N-order M-dimensional matrix may be a pulse position number of a MPPM(N, M) symbol. The method includes mapping integers to a super-triangular area of the N-order M-dimensional matrix and establishing a correlation between the integers and the N-order M-dimensional matrix elements. In this way, a correspondence between a bit sequence and a MPPM(N, M) symbol is established using a correspondence between the N-order M-dimensional matrix element and an index number of each dimension of the N-order M-dimensional matrix element. A mathematical expression of the number of integers mapped to each layer in each dimension of a super-triangular area of an N-order M-dimensional matrix is used to generate a lookup table T_{LUT}.

### RELATED APPLICATIONS

The present application claims priority to Chinese Pat. Appl. No. 2023103337514, filed Mar. 31, 2023, the contents of which are incorporated by reference herein in their entirety.

### TECHNICAL FIELD

The present invention belongs to the field of signal processing, and in particular, to systems and methods of MWD (Measurement While Drilling) telemetry in the field of petroleum exploration.

### BACKGROUND

Multi-pulse position modulation (MPPM) has high energy efficiency, and is widely applied to the fields of optical communication, deep space communication, while-drilling telemetry transmission, and the like. Generally, in MPPM, it is difficult to establish a regular mapping relationship between B (e.g., the encoded bit sequences) and the M time slots that MPPM maps. Therefore, at the transmitting end, the mapping of the bit sequences or symbols is usually realized by querying an encoding table. However, the memory complexity of the encoding table increases exponentially with the bit width of B. Therefore, a symbol having a large bit width may make the complexity of the encoding end unacceptable in some application scenarios.

For example, in a transmission-while-drilling system, the encoder may be located downhole in a rough or harsh environment, and the data sender (e.g., transmitter) of a measurement-while-drilling (MWD) telemetry system in the field of petroleum exploration is located in a deep underground well or hole having a depth of thousands of meters or even tens of thousands of meters. Generally, such an operating environment is very rough (high temperature and high pressure). Therefore, the storing and computing performance of the processor at the sending end (e.g., transmitter) are very limited, leading to occasional failure when implementing a complex encoding method.

A combination code (CC) is a variant of MPPM, and is widely applied to MWD telemetry systems in the field of petroleum exploration. However, an encoding table to map between the bits corresponding to a symbol and the symbol (or a corresponding transmitted pulse sequence) is generally adopted since it is difficult to establish a simple mapping relationship between the bits and the pulse sequence or symbol, regardless of the MPPM technique or other coding technique. As the bit width increases, the storage complexity of code tables grows exponentially, which is unacceptable for downhole transmitters operating in harsh environments.

### SUMMARY

The present invention solves one or more problems in the prior art in which multi-pulse position modulation may be unacceptable in petroleum exploration.

At least one technical solution of the present invention relates to a bit-symbol mapping method in multi-pulse position modulation (MPPM), which may be particularly useful in oil drilling/exploration. The method may comprise (1) mapping integers to a super triangle area of a multi-dimensional matrix, and (2) looking up or mapping one or more MPPM pulse sequences or symbols in a mapping or look-up table, wherein:
mapping the integers to the super-triangular area of the multi-dimensional matrix comprises:
representing transmission of M pulses in N time slots with MPPM(N, M) (e.g., to represent transmitted information), wherein the M pulses may be used to send a survey signal (e.g., in the well), and M is greater than or equal to 2;
constructing an N-order M-dimension matrix (e.g., matrix 1, FIG. 4) from MPPM(N, M), wherein each of the M dimensions of the matrix is respectively denoted as: R₁, R₂, . . . , R_{M} (e.g., R₁ through R_{M});
successively mapping integers from 0 to C_{N}^{M}−1 to a triangular area (e.g., the super triangular area) of the matrix, where C_{N}^{M} is a total number of MPPM(N, M) pulse sequences or symbols; and
mapping a 1^{st} dimension of the M dimensions from a subscript 1, a 2^{nd} dimension of the M dimensions from a subscript 2, up to an M^{th} dimension of the M dimensions from a subscript M′, wherein the subscripts 1, 2, . . . M′ denote an index number of an element in the M-dimensional matrix (e.g., in each dimension and/or in the respective dimension[s]), and M′ may be an integer of 1 to N.

In one example, the method may further comprise stacking a plurality of 1-dimensional matrices to form 2-dimensional triangle area, and when the subscript is 2 to N in the 2^{nd} dimension, a number of elements of 1-dimensional areas mapped from each subscript may comprise is, in sequence, 1, 2, 3, 4 . . . (e.g., the integers from 1 to C_{N}^{M}).

In another example, a 3-dimensional matrix may be formed by stacking a plurality of 2-dimensional matrices. In the 3^{rd} dimension, when the subscript is 3 to N, the number of elements of the 2-dimensional triangle area(s) mapped from each subscript comprises, in sequence, 1, 3, 6, . . . (e.g., N−2 numbers, from 1 to [N−2]+[N−1], where each number greater than 1 is according to the formula Fₓ=Fₓ₋₁+x, and x is successively an integer from 2 to N−2).

Similarly, an m-dimensional matrix may be formed by stacking (m−1)-dimensional matrices, where m is a variable integer of greater than or equal to 2 and less than or equal to M (e.g., decreasing in succession from M to 2). In the m^{th} dimension, a subscript i=m,m+1, . . . , N and the number of elements of the m−1-dimensional super triangular area to which each subscript maps, aᵢ^{(m)}, is:

$${a}_{i}^{( m )} = {C}_{i - 1}^{m - 1} , i = m , m + 1 , … , N$$

Thus, for N-order M-dimensional supermatrices

$${T}_{{\underbrace{N \times N \times … \times N}}_{M ↑}} ,$$

the number of elements of the super triangular area to which the integers are mapped may be equal to the total number of MPPM(N, M) pulse sequences or symbols, namely:

$${\sum }_{i = M}^{N} {a}_{i}^{( M )} = {\sum }_{i = M}^{N} {C}_{i - 1}^{M - 1} = {C}_{N}^{M}$$

A one-to-one mapping relation is established between the integers 0 to C_{N}^{M}−1 and each MPPM(N, M) symbol or pulse sequence; that is, a one-to-one mapping relation may be established between a K-bit bit sequence B and 2^{K} (e.g., the first 2^{K}) MPPM(N, M) symbols or pulse sequences, wherein K=└log₂^{C}^{_{N}}^{^{M}}┘, rounded down to the nearest integer. By employing the one-to-one mapping relationship, bit-to-symbol mapping of MPPM(N, M) is simplified.

Looking up or mapping the MPPM symbols in the look-up or mapping table comprises:
Establishing a lookup table T_{LUT} with Mₘₐₓ rows and Nₘₐₓ columns using aᵢ^{(m)}, wherein T_{LUT} has a space complexity that is less than that of an encoding table (e.g., a table directly correlating each possible bit sequence to an MPPM(N, M) symbol or pulse sequence), and Mₘₐₓ and Nₘₐₓ are maximum values of M and N, respectively. For example, according to the T_{LUT}, a bitmap for MPPM(N, M) where N≤Nₘₐₓ, M≤Mₘₐₓ may be realized in which the K-bit bit sequence B is mapped to M pulse positions of the N time slots in the MPPM(N, M) coding scheme.

Looking up or mapping the MPPM symbols in the look-up or mapping table (or generating the look-up or mapping table of MPPM pulse sequences or symbols) may further comprise initializing [p₁, p₂, . . . , p_{M}]=0, and B=the K-bit bit sequence(s) to be encoded; and calculating [p₁, p₂, . . . , p_{M}] as follows:
Rₘ is equal to the index of the first element greater than B in the M^{th} row of T_{LUT}, and p_{M}=Rₘ, where Rₘ is the index of the m^{th} dimension that includes B, and p_{M} may refer to the bit width of B corresponding to M (e.g., where M is the M^{th} dimension); then iteratively decrease m from M to 2, and for each value of m, sequentially perform the following calculation:
Rₘ=the index of the first element greater than B−T_{LUT}(m, Rₘ−1) in the (m−1)^{th} row of T_{LUT}, and

$${p}_{m - 1} = {R}_{m} .$$

In typical examples, the M^{th} row or line of T_{LUT} is a set of numbers (e.g., positive integers) in ascending order. These numbers are numbered in ascending order starting from 1, which is the index of the numbers. The lookup operation comprises searching T_{LUT} sequentially starting from the first number (i.e., the smallest number) until the first number (or integer) greater than B is found. The index of this found number is the index of the first element.

For example, representing transmission of M pulses in N time slots with MPPM(N, M) may comprise selecting integer values for each of M and N, where N>M (and may be greater than or equal to 2M).

The present invention uses the index of each dimension of the N-order M-dimensional matrix as a pulse position number of the MPPM(N, M) symbols, mapping the integers to a super-triangular area of the N-order M-dimensional matrix one by one, and establishing a corresponding relation between the integers and the N-order M-dimensional matrix elements. In this way, the corresponding relation between the bit sequences (to be encoded) and the MPPM(N, M) pulse positions or symbols is established by utilizing the corresponding relation between the N-order M-dimensional matrix element and the index number of each dimension thereof.

The present invention may also build up the mathematical expression of the mapped integers and/or numbers of/in each layer in each dimension of the super-triangular area of the N-order M-dimensional matrix (e.g., aᵢ^{(m)}=Cᵢ₋₁^{m-1}, i=m,m+1, . . . , N), and use the resulting mathematical expression to generate a lookup table T_{LUT}. The spatial complexity of T_{LUT} may be much less than that of a conventional MPPM(N, M) code table. Based on T_{LUT}, the method of encoding and/or mapping bits to MPPM(N, M) symbols in a lookup table is established, making it possible to widen the application range of multi-pulse position modulation technology. When the method of the present invention is adopted, specific benefits can be seen as follows: 1. the overhead of the memory is small, and the method can be applied to a system with limited memory, such as a single-chip microcomputer system; 2. the calculation overhead/logic is small, and can be applied to underground data transmission in oil exploration; 3. the mapping of bits to symbols is regular, and can be easily extended to any bit width and any combination of M and N (e.g., where M is at least 2 and N is at least 4).

The present invention may be described in Chen et al., Electronics 2023, 12, 4683, doi.org/10.3390/electronics12224683, the relevant portions of which are incorporated herein by reference.

### BRIEF DESCRIPTION OF THE DRAWINGS

FIG. 1 is an example of a pulse sequence corresponding to a MPPM(5,2) symbol mapped to a bit sequence 001.

FIG. 2 is an exemplary 2^{nd} dimension matrix of integers mapped by an exemplary MPPM(5, 2) coding scheme.

FIGS. 3A-C are exemplary 3^{rd} dimension matrices of integers mapped by an exemplary MPPM(5, 3) coding scheme.

FIG. 4 is a representation of an exemplary N-order M-dimension matrix.

### DETAILED DESCRIPTION

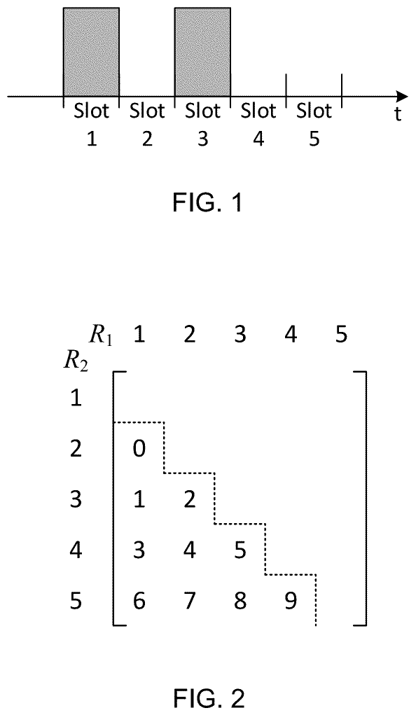

The encoding principles of MPPM(N, M) coding schemes include dividing the transmission time of a symbol into N time slots of equal length, and each symbol has M time slots in which to transmit a pulse. The remaining time slots are silent (i.e., do not include a pulse; see, e.g., slots 2, 4 and 5 in FIG. 1).

Definition 1: The time slot is a time interval with a duration of T_{S}, and a time slot with a sequence number of i is denoted as:

$${s}_{i} ∈ [ {t}_{0} + ( i - 1 ) {T}_{S} , {t}_{0} + i {T}_{S} ) , i = 1 , 2 , … , N$$

The term t₀+(i−1)T_{S} is the starting boundary of the time slot, and the term t₀+iT_{S} is the ending boundary of the slot. N consecutive and/or continuous slots form a coding interval for pulse position modulation s_{N} and/or an MPPM symbol s_{AC}: s_{AC}=[s₁, s₂, . . . , s_{N}]. t₀ is the starting boundary of the symbol (e.g., s_{AC}). The set Z_{N}={1, 2, . . . , N} is the set of time slot numbers in or on the coding interval s_{N}.

Definition 2: The multi-pulse position modulation (MPPM) coding scheme is as follows: M (M≥2) pulses are transmitted in N time slots (N>M) to represent information, denoted as MPPM(N, M). The MPPM(N, M) coding scheme has a total of C_{N}^{M} symbols, which can represent C_{N}^{M} different information states (bit sequences). Here,

$${c}_{N}^{M} = \frac{N !}{M ! ( N - M ) !} ,$$

and is the number of different possible combinations of M pulses in N time slots.

Taking the MPPM(5,2) coding scheme as an example, there are 10 different symbols (i.e., possible combinations of M pulses in N time slots) in total. When N is 5 and M is 2, K=└log₂^{C}^{_{N}}^{^{M}}┘ rounded down to the nearest integer is 3, and 8 symbols of this 10-symbol group can be used to represent the 8 possible unique 3-bit sequences of digital information (e.g., combinations of 0 and 1 states) in one-to-one mapping between the MPPM(5, 2) symbols or pulse sequences and all possible 3-bit sequences B.

The time slot positions coded as “1” in the time slot code in Table 1 below indicate that a pulse is transmitted in this time slot. For example, a pulse sequence represented by 10100 is shown in FIG. 1. The pulse sequence/time slot code 10100 corresponds to a digital bit sequence 001 and an MPPM(5, 2) symbol 2, as shown in Table 1.

Various configurations of MPPM coding schemes (e.g., number of possible symbols or code words) for different bit widths is shown in Table 2 below, wherein M is the number of pulses, and N is the number of time slots in each symbol. As can be seen from Table 2, an encoding table with a bit width of 16 bits may need to store 65536×6 units or pieces (e.g., bits) of pulse position data. This is an unacceptably high overhead burden in an application scenario where a single chip microcomputer (e.g., microcontroller or microprocessor) is the main component. When the value of M is equal to 1 or 2, it is relatively easy to establish a regular mapping relation between bit sequences and MPPM symbols, and related solutions have been proposed already. The main problem to be solved herein is how to establish a regular mapping relation between bit sequences and MPPM symbols when M≥3, thereby reducing the complexity of transmitters and/or receivers in underground drilling equipment and/or operations.

### MPPM(N, M) Bits-to-Symbols Mapping Method

### Super-Triangular Area Mapping of Integers to Multi-Dimensional Matrices

In the present MPPM(N, M) coding scheme, an N-order M-dimensional matrix

$${T}_{{\underbrace{N \times N \times … \times N}}_{M ↑}}$$

is constructed, and each dimension thereof is respectively denoted as: R₁, R₂, . . . , R_{M}. Integers from 0 to C_{N}^{M}−1 are sequentially mapped to an element of an M-dimensional tensor T, using the index number of the tensor element in each dimension as the pulse position of the codeword symbol mapped from the integer. Typically, the tensor is an M-dimensional matrix, and the integers are mapped to a triangular (2-dimensional or more, referred to as super-triangular) area of the matrix/tensor T. In some embodiments, the integers are mapped to a lower or lower left triangular region of the matrix (without diagonal elements). The 1^{st} dimension starts mapping from an index subscripted as 1, the 2^{nd} dimension starts mapping from an index subscripted as 2, up to an M^{th} dimension that starts mapping from an index subscripted as M. In some implementations, 0 may be mapped at T(1,2, . . . , M).

For example, for MPPM(5, 2), a two-dimensional 5×5 matrix may be constructed, and the integers 0-9 are mapped to the two-dimensional tensor T_{5×5} as shown in FIG. 2.

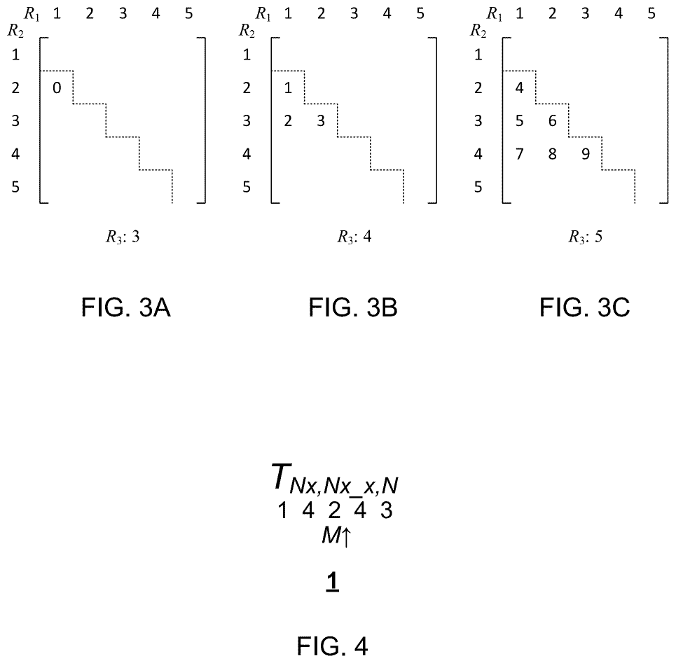

For MPPM(5,3), a three-dimensional 5×5×5 or (5×5×3) matrix may be constructed, as shown in FIGS. 3A-C. A first dimension of the three-dimensional matrix is shown in FIG. 3A, a second dimension of the three-dimensional matrix is shown in FIG. 3B, and a third dimension of the three-dimensional matrix is shown in FIG. 3C. In the case of the 5×5×5 matrix, the remaining dimensions may contain zero elements or integers.

As shown in FIG. 2, a two-dimensional triangular area may be formed by stacking a plurality of 1-dimensional matrices. In the 2^{nd} dimension, the numbers (e.g., integers) 1 to N are subscripted (the integers 1 to N also being subscripted in the 1^{st} dimension), and the number of elements of the 1-dimensional area are mapped by or according to each subscript as follows in sequence: 1, 2, 3, 4 . . . up to C_{N}^{M}. For example, the numbers 1 to C_{N}^{M} are positive integers, the 1-dimensional area may be one or more corresponding 1-dimensional matrices, the number of elements of the 1-dimensional area may be mapped into a super (e.g., lower left) triangle of the matrix (see, e.g., FIG. 2), and the number of elements by or according to each subscript may comprise non-negative integers up to C_{N}^{M}−1.

As shown in FIGS. 3A-C, a three-dimensional matrix may be formed by stacking a plurality of two-dimensional matrices. In the 3^{rd} dimension, the numbers (e.g., integers) 3 to N are subscripted, and the number of elements of the two-dimensional triangular areas to which each subscript maps sequentially is: 1, 3, and 6.

Similarly, the M-dimensional matrix may be formed by stacking M−1 dimensional matrices. In the M^{th} dimension, i=m,m+1, . . . , N (or i=M, M+1, . . . , N) are subscripted, and the number of elements of the M−1 dimensional super triangle area to which each subscript maps is:

$${a}_{i}^{( m )} = {C}_{i - 1}^{m - 1} , i = m , m + 1 , … , N$$

Thus, for an N-order, M-dimensional super-matrix

$${T}_{{\underbrace{N \times N \times … \times N}}_{M ↑}} ,$$

the number of elements of the super triangle area to which an integer is mapped is equal to the total number of MPPM(N, M) symbols, namely:

$${\sum }_{i = M}^{N} {a}_{i}^{( M )} = {\sum }_{i = M}^{N} {C}_{i - 1}^{M - 1} = {C}_{N}^{M}$$

That is, a one-to-one mapping relationship may be established between the integers 0 to C_{N}^{M}−1 and each symbol of the MPPM(N, M) scheme, and a corresponding one-to-one mapping may be established between all of the possible K-bit symbols B and 2^{K} (e.g., the first 2^{K}) symbols of the MPPM(N, M) scheme. Here, K=└log₂^{C}^{_{N}}^{^{M}}┘, └⋅┘, and represents a rounding down of K to the nearest integer. By using the one-to-one mapping relationship, the bit-to-symbol mapping of the MPPM(N, M) scheme is simplified, especially when M>2.

### A Look-Up Table for MPPM Symbol/Pulse Sequence Mapping

A lookup table T_{LUT} with Mₘₐₓ rows and Nₘₐₓ columns may be established using aᵢ^{(m)}). The T_{LUT} may have a space complexity that is less than that of a corresponding encoding table. For example, the look-up table when Nₘₐₓ=24, Mₘₐₓ=6 is as in Table 3 below. Table 3 thus correlates the number of elements aᵢ^{(m)} of the super triangular area to each dimension and/or subscript of the mapping tensor.

According to the T_{LUT}, the bit-to-symbol mapping of MPPM(N, M) where N≤Nₘₐₓ, M≤Mₘₐₓ is realized.

Assuming that a given K-bit sequence B is mapped to the M pulse positions in the N time slots of the MPPM(N, M) scheme as: [p₁, p₂, . . . , p_{M}], the mapping table and/or the lookup table may be coded and/or generated as follows:

```
Initialization:
  [p₁, p₂, . . . , p_{M}] = 0;
  B = K-bit sequence(s) to be encoded;
Calculate [p₁, p₂, . . . , p_{M}] from the mapping table:
  Rₘ = the index of the first element greater than B in the M^{th} row
  of T_{LUT};
  p_{M} = Rₘ;
  for (m decreases from M to 2)
    $B = B - {T}_{LUT} ( m , {R}_{m} - 1 )$
    Rₘ = the index of the first element greater than B in the (m − 1)^{th}
    row of T_{LUT};
    ${p}_{m - 1} = {R}_{m} ;$
  End
```

Since T_{LUT} contains the number of elements in each layer of each dimension of the super-triangular region mapped on the M-dimensional tensor T, the index p=[R₁, R₂, . . . , R_{M}] of the integer corresponding to each dimension of T can be computed from any integer between 0 and C_{N}^{M}−1. Taking p as a codeword symbol of the MPPM(N, M) coding scheme can realize the mapping of bit sequences to the codeword symbols of the MPPM(N, M) scheme, which can greatly reduce the space complexity at the MPPM(N, M) coding end (e.g., the encoder and/or transmitter).

Since each row of T_{LUT} is arranged in ascending order, it has low lookup complexity. Alternatively or additionally, each row of the T_{LUT} is a sequential table, so that a quick table lookup process or algorithm can be adopted, and a sequence table lookup process or algorithm can also be adopted for the table lookup.

Comparing the encoding complexity of the present MPPM coding scheme with that of an existing code (e.g., a conventional combinatorial or combination code [CC]):

It is assumed that the bit width range k of a bit sequence should be encoded at the encoding end as: k=1,2, . . . , K bits, and the symbols corresponding to each bit sequence are encoded using the MPPM(N_k, M_k) scheme. Let the lookup table of the MPPM code have Mₘₐₓ=M_{K} rows, and Nₘₐₓ=N_{K} integers in each row. Since the integers in each row of the lookup table are arranged in ascending order, a binary search approach can be adopted in the lookup table. The number of times of searching for one line or row in the lookup table (e.g., using a bisection method) is at most no more than └log₂ N_{K}┘+1. A k-bit sequence to be encoded uses Mₖ times the maximum number of searches in the binary search approach, and the total number of searches is no more than └log₂ N_{K}┘+1, so the complexity of the encoding time in the present MPPM coding scheme is O(Mₖ log₂ N_{K}). The MPPM coding scheme stores a lookup table with size of M_{K}×N_{K}, so its space complexity is O(M_{K}N_{K}).

For k-bit wide bit sequences, the existing (e.g., CC) coding scheme generates a code table with size of 2^{k} to implement the mapping of bit sequences to pulse positions. In the existing encoding process, the coding table is directly indexed using a bit sequence, and therefore the time complexity of the existing coding scheme is O(1). The existing code also stores a complete symbol pulse position mapping table, along with the k-bit code table that requires a storage space with size of 2^{k}. In general, the number of combinations C_{N}_{ₖ}^{M}^{ₖ} to satisfy the pulse positions when selecting M_{K} and N_{K} in the existing coding scheme is greater than the total number of k-bit sequences 2^{k} to reduce redundancy (that is, 2^{k}≤C_{N}^{M}<2^{k+1}). Thus, the space complexity of the existing encoding to store a k-bit encoding table is actually O(2^{k})=O(C_{N}_{ₖ}^{M}^{ₖ}).

In practical applications, the existing coding scheme needs to store all encoding tables corresponding to k=1,2, . . . , K bit widths, which means the total space size of the encoding table is Σₖ₌₁^{K}2^{k}, while the present MPPM coding scheme only needs to store a lookup table of M_{K}×N_{K}. Therefore, compared with the existing encoding scheme, although the time complexity of MPPM encoding is slightly higher than that of CC encoding, the space complexity thereof is much less than that of CC encoding, which effectively solves the problem that the space complexity of existing CC encoding increases exponentially with the increase in the bit width k.

TABLE 1
MPPM(5, 2) Encoding Table

| Symbol | Bit Sequence | Pulse Positions | Time Slot Code |
|---|---|---|---|
| 1 | 000 | 1, 2 | 11000 |
| 2 | 001 | 1, 3 | 10100 |
| 3 | 010 | 1, 4 | 10010 |
| 4 | 011 | 1, 5 | 10001 |
| 5 | 100 | 2, 3 | 01100 |
| 6 | 101 | 2, 4 | 01010 |
| 7 | 110 | 2, 5 | 01001 |
| 8 | 111 | 3, 4 | 00110 |
| 9 | — | 3, 5 | 00101 |
| 10 | — | 4, 5 | 00011 |

TABLE 2
M and N parameter table commonly used in MPPM coding schemes

| Bit | | | Number of | Bit | | | Number of |
|---|---|---|---|---|---|---|---|
| width | M | N | Symbols | width | M | N | Symbols |
| 1 | 1 | 2 | 2 | 9 | 4 | 13 | 512 |
| 2 | 1 | 4 | 4 | 10 | 4 | 15 | 1024 |
| 3 | 2 | 5 | 8 | 11 | 4 | 17 | 2048 |
| 4 | 2 | 7 | 16 | 12 | 5 | 16 | 4096 |
| 5 | 2 | 9 | 32 | 13 | 5 | 18 | 8192 |
| 6 | 3 | 9 | 64 | 14 | 6 | 18 | 16384 |
| 7 | 3 | 11 | 128 | 15 | 6 | 20 | 32768 |
| 8 | 3 | 13 | 256 | 16 | 6 | 22 | 65536 |

TABLE 3
Lookup table T_{LUT} of MPPM with Nₘₐₓ = 24, Mₘₐₓ = 6

| m | aᵢ^{(m+1)} |
|---|---|
| 1 | 1, 2, 3, 4, 5, 6, 7, 8, 9, 10, 11, 12, 13, 14, 15, 16, 17, 18, 19, 20, 21, |
| | 22, 23, 24 |
| 2 | 0, 1, 3, 6, 10, 15, 21, 28, 36, 45, 55, 66, 78, 91, 105, 120, 136, 153, |
| | 171, 190, 210, 231, 253, 276 |
| 3 | 0, 0, 1, 4, 10, 20, 35, 56, 84, 120, 165, 220, 286, 364, 455, 560, 680, |
| | 816, 969, 1140, 1330, 1540, 1771, 2024 |
| 4 | 0, 0, 0, 1, 5, 15, 35, 70, 126, 210, 330, 495, 715, 1001, 1365, 1820, |
| | 2380, 3060, 3876, 4845, 5985, 7315, 8855, 10626 |
| 5 | 0, 0, 0, 0, 1, 6, 21, 56, 126, 252, 462, 792, 1287, 2002, 3003, 4368, |
| | 6188, 8568, 11628, 15504, 20349, 26334, 33649, 42504 |
| 6 | 0, 0, 0, 0, 0, 1, 7, 28, 84, 210, 462, 924, 1716, 3003, 5005, 8008, |
| | 12376, 18564, 27132, 38760, 54264, 74613, 100947, 134596 |

As mentioned above, the present invention is useful for solving problems in signal transmission (e.g., wireless signal transmission) in petroleum exploration and/or extraction. For example, the method may further comprise transmitting the MPPM pulse sequences to a well in the ground (e.g., to a receiver such as a wireless receiver in the well). The equipment in the well may optionally include and a decoder configured to convert the MPPM pulse sequences to a digital signal (e.g., for processing by a processor in the equipment). The MPPM pulse sequences may be transmitted from a transmitter above the ground and/or outside of the well, and may comprise a survey signal. The well may be an oil exploration well or an oil extraction well. Thus, the well may have a depth of at least 500 m (e.g., 1000 m or more, 2000 m or more, etc.) and a width or diameter of 10 cm to 2 m (e.g., 15-100 cm, or any value or range of values therein).

The method may also further comprise receiving additional MPPM pulse sequences or symbols from equipment in the well during a measurement while drilling (MWD) process. The equipment in the well may thus comprise one or more sensors configured to make one or more measurements in the well, a processor (e.g., a microprocessor or microcontroller) configured to process information from the sensor(s) and generate a digital signal therefrom, an encoder configured to convert the digital signal to MPPM(N, M) code (e.g., using the present method), and a second transmitter configured to transmit the MPPM(N, M) code to a receiver outside the well and/or above the ground. In addition, the above-ground equipment may further comprise a second receiver (e.g., wireless receiver) configured to receive the MPPM(N, M) code and a second decoder configured to convert the MPPM(N, M) code to a digital signal.

What is claimed:

1. A method of mapping bit sequences in multi-pulse position modulation (MPPM), comprising: mapping integers to a super triangle area in a multi-dimensional matrix, and generating a look-up or mapping table of MPPM pulse sequences or symbols; wherein:
mapping the integers to the super-triangular area of the multi-dimensional matrix comprises:
representing transmission of M pulses in N time slots with MPPM(N, M), wherein M is greater than or equal to 2;
constructing an N-order M-dimension matrix from MPPM(N, M), wherein each of the M dimensions is respectively denoted as: R₁, R₂, . . . , R_{M};
successively mapping the integers from 0 to C_{N}^{M}−1 to a triangular area of the matrix; and
mapping a first dimension of the M dimensions from a subscript 1, up to an M^{th} dimension of the M dimensions from a subscript M′, wherein the subscripts 1 through M′ denote an index number of an element in the M-dimensional matrix, and M′ is integer of 1 to N;
thereby establishing a one-to-one mapping relation between the integers 0 to C_{N}^{M}−1 and each MPPM(N, M) pulse sequence or symbol; and
generating the look-up or mapping table of the MPPM pulse sequences or symbols comprises:
establishing a lookup table with Mₘₐₓ rows and Nₘₐₓ columns, wherein the lookup table includes a bitmap for MPPM(N, M) such that N≤Nₘₐₓ and M≤Mₘₐₓ, where Mₘₐₓ and Nₘₐₓ are maximum values of M and N, respectively;
initializing [p₁, p₂, . . . , p_{M}]=0 and B=a K-bit bit sequence to be encoded, where K=log₂ C_{N}^{M}, rounded down to the nearest integer; and
mapping each K-bit bit sequence to M pulse positions in the N time slots in the lookup table.

2. The method of claim 1, wherein mapping comprises stacking a plurality of 1-dimensional matrices to form a 2-dimensional triangle area.

3. The method of claim 1, further comprising transmitting the M pulses to a well.

4. The method of claim 1, wherein M′ is an integer of 1 to N.

5. The method of claim 1, wherein when the subscript is 2 to N in the 2^{nd} dimension, a number of elements of 1-dimensional areas mapped from each subscript comprises, in sequence, 1, 2, 3, 4 . . .

6. The method of claim 1, wherein M is at least 3, and the method further comprises stacking a plurality of the 2-dimensional matrices to form a 3-dimensional matrix.

7. The method of claim 6, wherein in the 3^{rd} dimension, when the subscript is 3 to N, a number of elements of the 2-dimensional triangle areas mapped by each subscript is, in sequence, 1, 3, 6, . . .

8. The method of claim 1, further comprising stacking M 1-dimensional matrices to form an M-dimensional matrix, wherein in the M^{th} dimension, a subscript i=m,m+1, . . . , N and a number of elements aᵢ^{(m)} of the M 1-dimensional super triangular area to which each subscript maps comprises aᵢ^{(m)}=Cᵢ₋₁^{m-1}, i=m,m+1, . . . , N.

9. The method of claim 8, wherein the lookup table is established using aᵢ^{(m)}.

10. The method of claim 1, wherein the number of elements of the super triangular area to which the integers are mapped is equal to the total number of MPPM(N, M) pulse sequences or symbols.

11. The method of claim 1, wherein the integers are 0 to C_{N}^{M}−1.

12. The method of claim 1, wherein mapping the integers to the super-triangular area of the multi-dimensional matrix establishes a one-to-one mapping relation between each sequence of digital bits to be encoded and the MPPM pulse sequences or symbols.

13. The method of claim 1, wherein each sequence of the digital bits to be encoded has a width of N-M bits.

14. The method of claim 1, wherein the lookup table has a space complexity less than that of a corresponding encoding table.

15. The method of claim 1, wherein the mapping table comprises the integers and the multi-dimensional matrix.

16. The method of claim 1, wherein generating the look-up table of MPPM pulse sequences or symbols further comprises:
calculating [p₁, p₂, . . . , p_{M}] as follows:
Rₘ=the index of the first element greater than B in the M^{th} row of T_{LUT}, and
p_{M}=Rₘ;
then decrease m from M to 2, and sequentially calculate:
$$B = B - {T}_{LUT} ( m , {R}_{m} - 1 ) ;$$
Rₘ=the index of the first element greater than B in the (m−1)^{th} row of T_{LUT}; and
$${p}_{m - 1} = {R}_{m} .$$

17. The method of claim 3, wherein the M pulses are in a survey signal.

18. The method of claim 3, wherein the well is an oil exploration well or an oil extraction well.

19. The method of claim 18, wherein the well has a depth of at least 500 m and a width or diameter of 10 cm to 2 m.

20. The method of claim 3, further comprising receiving additional MPPM pulse sequences or symbols from equipment in the well during a measurement while drilling (MWD) process.
